(19) United States
(12) Patent Application Publication
(10) Pub. No.: US 2011/0261094 A1
(43) Pub. Date: Oct. 27, 2011

(54) METHOD TO DISPLAY IMAGES ON A DISPLAY DEVICE USING BIT SLICE ADDRESSING TECHNIQUE

(75) Inventor: Temkar N. Ruckmongathan, Karnataka (IN)

(73) Assignee: RAMAN RESEARCH INSTITUTE, Bangalore, Karnataka (IN)

(21) Appl. No.: 13/055,993

(22) PCT Filed: Jan. 21, 2011
(86) PCT No.: PCT/IB11/50273

§ 371 Date: Jan. 26, 2011

(30) Foreign Application Priority Data
Jan. 28, 2010 (IN) 221/CHE/2010
Jan. 17, 2011 (IN) 152/CHE/2011

(51) Int. Cl. G09G 5/10

(52) U.S. Cl. 345/697; 345/690

(57) ABSTRACT

Optical and electronic means of addressing are combined to flash bit-sliced images rapidly in a sequential manner to achieve enormous reduction in circuit as well as cost of data drivers in display devices. Also, light source i.e. backlight or front light switching scheme is used to reduce power consumption of light source in display devices for both static and dynamic images with high contrast. Bit slice addressing (BSA) preserves colour purity of images at all angles in fast responding liquid crystal displays with simple data drivers. Colour purity of images is also preserved at all angles of view due to a viewing angle characteristic of bit slice addressing that is independent of gray shades.

### FIELD OF THE INVENTION

The disclosure relates to display devices and more particularly relates to reduction of hardware complexity of data drivers, reduction of power consumption of light sources in display devices, achieve viewing angle characteristics that is independent of grayscale, achieve response times that of independent of initial and final gray shades, achieve colour purity of images at all angle, eliminate motion blur, and have wide margin of voltage to drive pixels to either one of the two states.

### BACKGROUND OF THE INVENTION

A light source is employed to illuminate non-emissive displays and the light transmission through pixels is controlled to display images in non-emissive displays. For example, in an active matrix liquid crystal display (AM-LCD) the output of a digital to analog converter (DAC) is applied to each column of the display and a thin film transistor (TFT) at each pixel (at the intersection of row and column electrodes) is used to sample and hold the output voltage of DAC. FIG. 1(a) shows an 8-bit DAC to display 256 grayscales as a specific example. FIG. 1(b) shows one stage of data integrated circuit (IC) that drives a column of a display device to display a predetermined number of grayscales (2^{g}) with a g-bit DAC.

Light transmission through pixels in LCD depends on the applied voltage as well as the viewing angle i.e. the angle at which the display is viewed. FIG. 1 (c) shows electro-optic curves of an LCD for three different viewing angles. One can see that light transmission is different for the three curves even though the voltage is same as shown in dotted lines. It is evident from FIG. 1(c), that the viewing angle characteristics of a pixel depend on the grayscale of pixel. In a colour LCD, the viewing angle characteristics will depend on the grayscale of sub-pixels (of the three primary colours i.e. red, green and blue). Hence, colour of a pixel which is a combination of the three colour sub-pixels depends on the viewing angle and it is difficult to maintain the colour purity of images i.e. achieve a colour that is independent of viewing angle. Although, contrast inversion at oblique viewing angles colour shift are minimized in LCDs it is difficult to eliminate them altogether and achieve colour purity at all viewing angles. Colour shift with viewing angle is one of the major disadvantages of LCD.

Grayscale to grayscale response times i.e., the time taken to switch pixels from one grayscale to another depends on initial and final grayscale in LCDs and this again results in reducing colour purity of images especially in fast moving images.

Adaptive dimming of backlight is used to reduce power consumption of LCDs. Average picture level (APL) of a movie is about 25% and when some scenes in a movie have a low brightness then the backlight is dimmed selectively in those frames and also in clusters of pixels in individual frames to reduce power consumption of the display.

Further, DAC of 6 to 10 bits is used to drive each column of in the matrix LCD in conventional method to display images.

Motion blur is another visual artefact that is observed in fast moving images on AM-LCD which is suppressed by introducing blank frames between two successive frames.

In DMD (Digital Micromirror Device), every pixel is a reflective minor. A DMD chip consists of several hundred thousand micro minors arranged in a rectangular array which correspond to pixels of an image. The minors can be individually tilted by an angle of about 12°, to an ON or OFF state. In the ON state, light from the projector bulb is reflected into the lens and the corresponding pixel appears bright on the screen. In the OFF state of the micro minor, the light is directed elsewhere (usually onto a heat sink), and the corresponding pixel on the screen appears dark. The micro-minors are switched ON and OFF at a fast rate to display grayscales, and the ratio of “ON” time to “OFF” time determine the grayscale (binary pulse-width modulation). In a single chip projection system, colour is achieved by adding three primary colour images sequentially by using a colour wheel; three colour sources instead of white light and three DMD are used to project the three colour images simultaneously on the screen.

The MEMS displays are reflective type displays wherein light of specific wavelength constructively interfere depending on the distance between two reflecting surfaces. It uses interferometric modules (IMOD) technology in which a mirrored surface is overlaid with nanoscale flexible membranes that are controlled by electrical charges. Ambient light is reflected from the mirror and back through the membranes, which refract the light. The membrane-to-substrate gaps determine the colours rendered, so no colour filters are required. The membranes are bi-stable, which allows low energy dissipation, analogous to a SRAM cell. Once the pixel membranes display a colour, virtually no energy is required to maintain that colour, and energy is required only when the pixel colour is changed. The display requires no backlighting which leads to power savings in bright ambient conditions. A front light is necessary to read the display in dark rooms.

### BRIEF DESCRIPTION OF THE ACCOMPANYING DRAWINGS

FIG. 1(a) illustrates a prior art 8-bit digital to analog converter (DAC) used in data drivers integrated circuits of AM-LCD several hundred to several thousands of such DAC are used to drive LCDs.

FIG. 1 (b) illustrates a stage of display device data driver for AM-LCD.

FIG. 1(c) illustrates variation of transmission that depends on viewing angle even though the voltage across the pixel is same in AM-LCD.

FIG. 2(a) illustrates an image of Lena digitized to 512×512 pixels and 8-bits.

FIG. 2(b) illustrates a binary (bit-plane) image of the most significant bit (MSB) of the Lena (b₇ of the 512×512 pixels).

FIG. 2(c) illustrates a binary (bit-plane) image of the 2^{nd} most significant bit (MSB) of the Lena (b₆ of the 512×512 pixels).

FIG. 2(d) illustrates a bit-plane image of the 3^{rd} most significant bit (MSB) of the Lena (b₅ of the 512×512 pixels).

FIG. 3(a) illustrates a colour image of “Lena”.

FIG. 3(b) illustrates a bit-plane-frame (BPF) of b₇ i.e., binary image of most-significant bit of green colour of the image shown in FIG. 3(a).

FIG. 3(c) illustrates a bit-plane-frame (BPF) of b₆ i.e., binary image of the 2^{nd} most significant bit of green colour of the image shown in FIG. 3(a).

FIG. 4(a) illustrates intensity modulation of backlight for 256 gray shades when the time taken to switch pixels from ON to OFF or OFF to ON is small.

FIG. 4(b) illustrates the method of increasing the duration for most significant bit (b₇) to reduce the peak intensity by about 44% when the time taken to switch pixels ON or OFF is small.

FIG. 5(a) illustrates the original image “Lena” used for bit slicing

FIG. 5(b) illustrates the red colour image of FIG. 5(a).

FIG. 5(c) illustrates the green colour image of FIG. 5(a).

FIG. 5(d) illustrates the blue colour image of FIG. 5(a).

FIG. 6 illustrates the large margins of voltage that allow some deviation in drive voltages without affecting the state of pixels when bit slice addressing is used to drive LCD.

FIG. 7(a) illustrates a bit-plane image of the MSB (b₇) of the image Barbara (512×512 pixels with intensity of backlight is set to the maximum i.e., proportional to 2⁷).

FIG. 7(b) illustrates a bit-plane image of the b₆ of the image Barbara (512×512 pixels with intensity of backlight is set to 50% of the maximum i.e., proportional to 2⁶).

FIG. 7(c) illustrates a bit-plane image of b₅ of the image Barbara (512×512 pixels with intensity of backlight set to 25% of the maximum i.e., proportional to 2⁵).

FIG. 7(d) illustrates an image reconstruction by adding BSF of bits 8 to 5 with corresponding intensity control of backlight.

FIG. 7(e) illustrates the original Barbara image with 8-bits of grayscale.

FIG. 8 illustrates a test image digitized to 1024×1024 pixels and eight bits.

FIG. 9 illustrates a pepper image digitized to 512×512 pixels and 8-bits.

FIG. 10 shows light transmission curve is different at different viewing as shown in the figure; therefore light transmission varies significantly for a voltage applied to the pixel when grayscale is achieved by controlling the applied voltage to the pixel.

FIG. 11 illustrates data driver of bit slice addressing to drive column in the display; Output has two voltages to switch pixels either to “ON” state or “OFF” state.

FIG. 12 illustrates switching OFF of light source for a predetermined time to allow pixels to switch from one state to another state during transition from one binary image (BSF) to another binary image.

FIG. 13 illustrates the system to display an image on a display device with bit slice addressing technique.

FIG. 14 illustrates the reduction in backlight power in just one binary image (BSF) corresponding to b₇ of green colour image of “Lena”. About 20% of light source power is achieved by switching OFF light to 56 clusters of pixels with all pixels in OFF state in the bit plane image with 256 clusters of pixels.

### DETAILED DESCRIPTION OF THE INVENTION

The primary embodiment of the present disclosure is a bit slice addressing method to display an image on a display device by combining electrical and optical means, said method comprising acts of displaying binary images of a predetermined number of grayscale bits in succession; modulating simultaneously the intensity of light source for each binary image of grayscale bits; and displaying the intensity modulated binary images at a predetermined rate to view the complete image.

In yet another embodiment the display device is a non-emissive display device such as transmissive, reflective or trans-reflective.

In still another embodiment the display device is a fast responding liquid crystal displays (LCD) such as blue phase LCD (BPLCD) and ferroelectric LCD (FLCD).

In still another embodiment the display device is a digital micro-minor-device (DMD).

In still another embodiment the display device is a micro-electro mechanical system (MEMS) type display.

In still another embodiment the display device is an electro-wetting display.

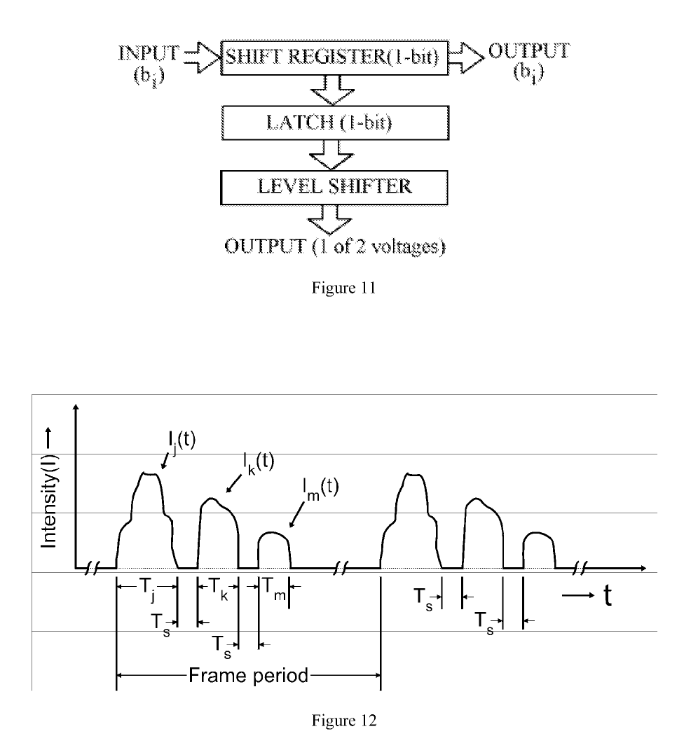

In still another embodiment the binary images of the bit-planes are displayed with drivers that can apply any one of two predetermined voltages to the display as in FIG. 11.

In still another embodiment of the disclosure the integrated value of intensity of light during the period of display of each binary image of a bit is proportional to the binary weight of the bit.

In still another embodiment of the disclosure the product of light intensity and duration of light is proportional to binary weight of the bit corresponding to the binary image that is being displayed when the light intensity is constant during a period.

In still another embodiment the light intensity is proportional to binary weight of the bit corresponding to the binary image that is being displayed if duration of display of binary images is equal.

In still another embodiment the number of occurrences of binary image and the intensity of ON pixels in the binary images are controlled depending on bit weight of binary image.

In still another embodiment the intensity of ON pixels in binary images is increased and the number of occurrences of binary images is reduced for a predetermined number of least significant bits of gray shade or grayscale to reduce the dynamic range of the intensity of light source.

In still another embodiment the intensity of ON pixels in binary images is increased and the number of occurrences of binary images is reduced for a predetermined number of least significant bits of grayscale (gray shade) to reduce the number of binary images displayed per unit time.

In still another embodiment the light source is switched OFF for a predetermined duration (Tₛ) to allow pixels to switch from one state to another state during transition from one binary image to another binary image as shown in the FIG. 12.

In still another embodiment the duration of display of binary image and the duration of light intensity are controlled in a predetermined manner.

In still another embodiment the number of light sources that are switched ON or OFF is controlled in a predefined manner to achieve intensity modulation of light.

In still another embodiment the number of light sources that are switch ON and the duration of ON period of each light source are controlled to achieve intensity modulation of light.

In still another embodiment intensity modulation of light source is achieved by varying the power applied to the light source.

In still another embodiment the light source is switch OFF for a binary image when a grayscale bit is logic 0 for all pixels in the binary image to reduce power consumption of the display.

In still another embodiment the light source is switch OFF for all clusters of pixels with grayscale bit as logic 0 in binary images to reduce power consumption of backlight for static and dynamic images with full contrast.

In still another embodiment light source is switched OFF for clusters of pixels in binary images of most significant bits of gray shade to reduce power consumption of the light source for static and dynamic images with full contrast.

In still another embodiment a predetermined sequence is employed to display binary images of gray shade bits to eliminate motion blurs.

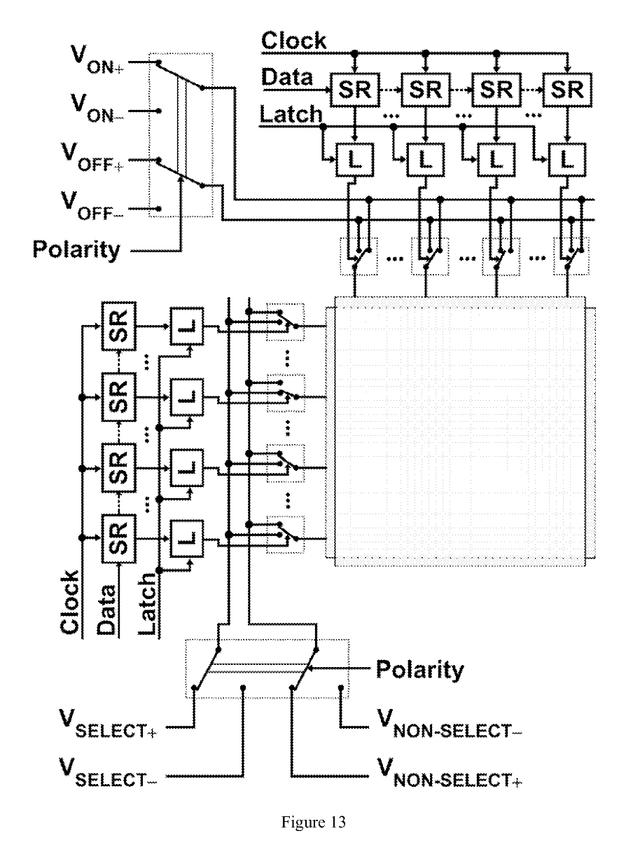

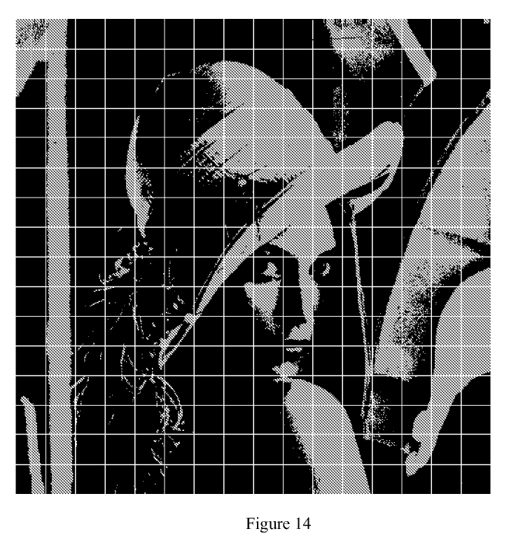

Another embodiment of the present disclosure is a system to display an image on a display device with bit slice addressing technique, the system comprises of a display screen to display an image, wherein the display is selected from a group of displays comprising of fast responding liquid crystal displays (LCD) such as blue phase LCD (BPLCD) & ferroelectric LCD (FLCD), digital micro-minor device (DMD), micro-electro mechanical system (MEMS) displays and electro-wetting display; data drivers to drive the display consisting of a 1-bit shift register, a latch and 2:1 analog multiplexer to drive the display; light source to illuminate the display; and a controller to control the intensity of light source by varying the number of light sources that are ON and duration for which they are ON to vary intensity of ON pixels in binary images. The system block diagram is shown in FIG. 13.

In yet another embodiment of the present disclosure the 2:1 analog multiplexer can be replaced by a level shifter.

The disclosure overcomes the drawbacks of the conventional method mentioned in the background. Bit-Slice Addressing (BSA) combines electrical and optical means of addressing; electrical means to use LCD as a dynamic mask and optical means to achieve grayscales. A wide range of intensities can be obtained by adding a few (≦g) discrete intensities based on binary number representation of intensity (I_{x,y}) as shown in (1).

$${I}_{x , y} = {\sum }_{i = 0}^{g - 1} {b}_{i} \cdot {2}^{i} \qquad ( 1 )$$

Wherein bi is either 0 or 1 and g is the number of bits. For example, 256-intensities can be obtained with just 8 discrete intensities as shown below:

I_{x,y}=2⁷b₇+2⁶b₆+2⁵b₅+2⁴b₄+2³b₃+2²b₂+2¹b₁+2⁰b₀

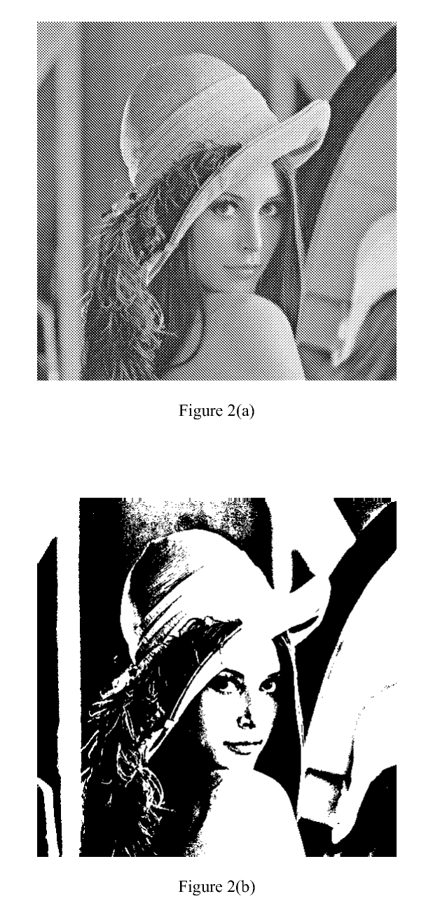

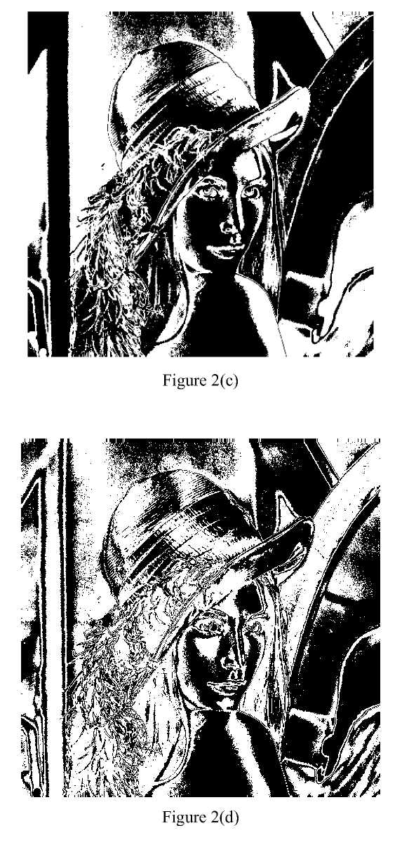

An image that extensively used in image processing literature and digitized to 8-bits of gray shade or gray scale is shown in FIG. 2(a). Each bit, i.e. from the most significant bit (MSB) to the least significant bit (LSB) of the image is used to obtain a binary or bit-plane-image as shown for the most significant bit (MSB) i.e., b₇ of the image in FIG. 2(b). Bit-plane-image of b₆ and b₅ are shown in FIG. 2(c) and FIG. 2(d) respectively.

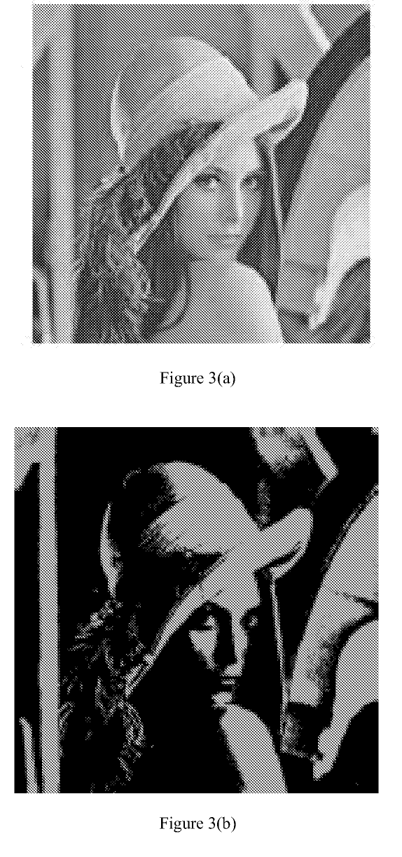

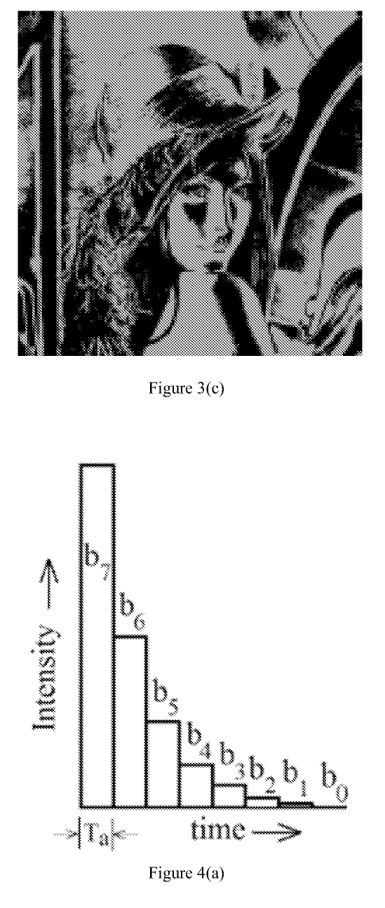

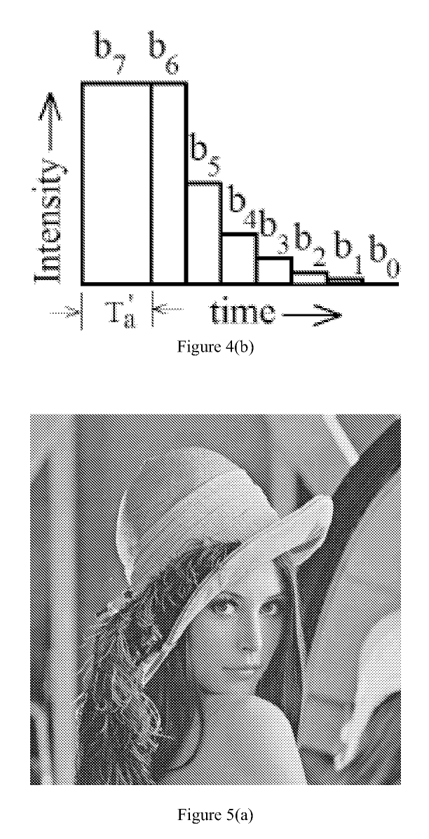

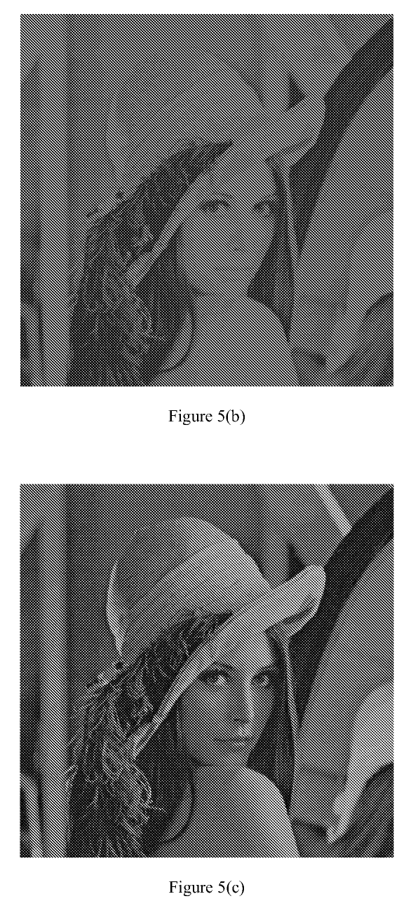

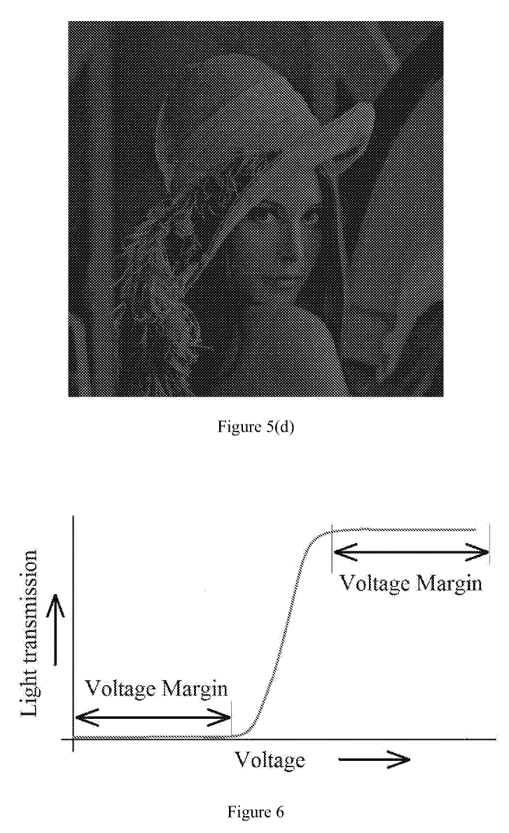

Each bit i.e., -bi of pixels is used to construct a mask called ‘bit plane frame’ (BPF) or binary image that allows light to pass through when bit-bi is logic-1 and blocks light when bit-bi is logic-0. Similarly, BPFs of colour images can be obtained for the 3-primary colours. BPFs of b₇ and b₆ of green image of the FIG. 3(a) are shown in FIGS. 3(b) and 3(c). Liquid crystal displays (LCD) with fast response can be used as a dynamic mask. In bit slice addressing (BSA), BPFs (binary images) of g-bits are displayed sequentially and intensity of light source of LCD is controlled simultaneously to be proportional to the bit-weight (2ⁱ) as shown in FIG. 4(a). The light source can be located either at the back of the display (backlight) or front of the display (front light). Sequential and rapid display of BPFs with intensity modulation will be perceived as gray scale image due integration in the eye. Colour images are also displayed either with sub-pixels of primary colours in parallel mode or by employing colour sequential mode in combination with BSA if the response times of LCD is short enough. FIGS. 5(b), 5(c) and 5(d) show the images of the primary colours RGB of the image (“Lena”) in FIG. 5(a) and the original image in FIG. 5(a) obtained by combining all the three images of primary colour i.e., images in FIG. 5(b), FIG. 5(c) and FIG. 5(d). BSA relies on binary representation of intensity of pixels, fast response of a non-emissive display device, fast switching of light source for intensity modulation, and persistence of vision. Fast responding LCDs like blue phase liquid crystal display (BPLCD), Ferro-electric displays and other bi-stable displays with fast response times may also driven with BSA. DMD (Digital Micromirror Device) or DLP (Digital Light Processing) and MEMS (Micro-Electro Mechanical Systems) displays can also be driven using the BSA in reflective mode of operation.

Bit slice addressing of the present disclosure ensures colour purity of pixels at all angles because pixels are driven either to ON state by applying voltages far above the saturation voltage or to OFF state by applying a voltage much below the threshold voltage of the electro-optic response as shown in FIG. 6, wherein the change in light transmission is small even with large change in applied voltage and grayscale is achieved by controlling the intensity of light source. Also, grayscale to grayscale response times (time taken to change from one grayscale to another grayscale) of LCD depends on the initial and final grayscales. Hence, colour of pixels that is obtained by mixing lights from the three sub-pixels of primary colour gets distorted especially when fast moving images are displayed. Bit slice addressing of the present disclosure achieves better colour purity of images because grayscale to grayscale response times is independent of initial and final grayscales because pixels are always switched from ON to OFF state Or OFF to ON state irrespective of the grayscale and also because viewing angle characteristics of the display device is independent of grayscales when pixels are driven only to ON or OFF as in the bit-slice addressing.

Bit slice addressing of the instant disclosure can be used to display grayscales by modulating the intensity of the light source (i.e. either front light or backlight source) of DMD or the MEMS based displays in a predetermined manner while displaying bit-plane images.

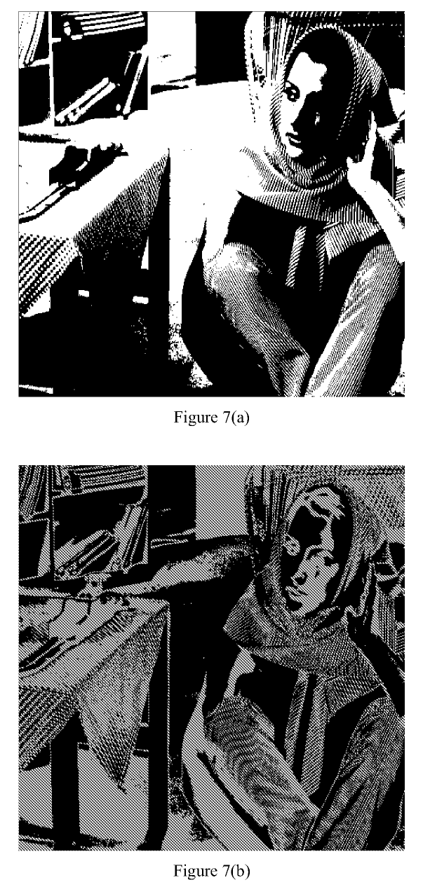

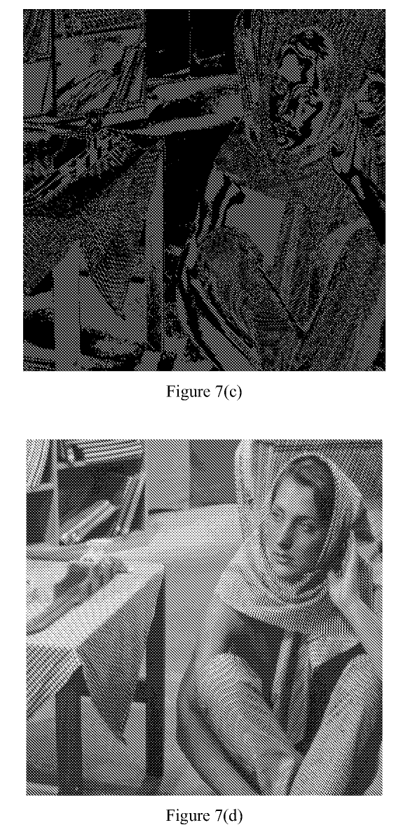

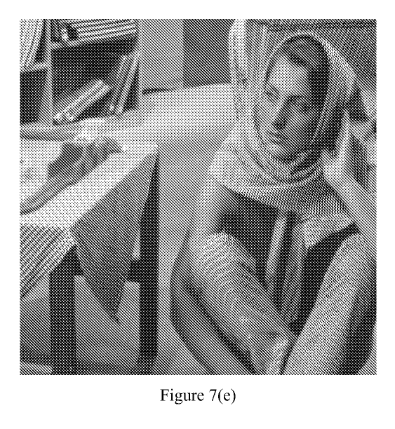

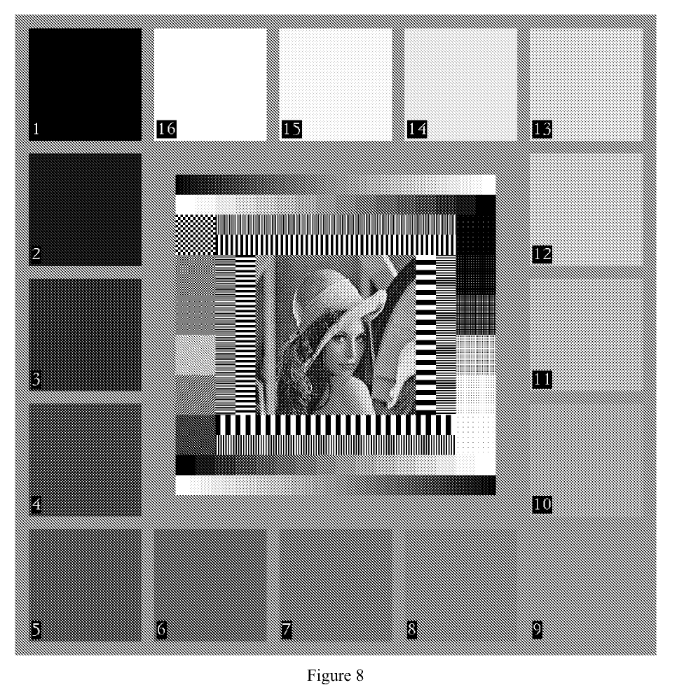

Three sub-images of an image i.e., the bit-plane-images of bits b₇, b₆ and b₅ with the intensity of light source in the ratio of 128:64:32 respectively are shown in FIGS. 7(a), 7(b) and 7(c). An image that is obtained by adding the most significant 4-bit-plane-images with light source intensities of 128, 64, 32 and 16 respectively are shown in FIG. 7(d) and the original image quantized to 8-bits is shown in FIG. 7(e). The error in the intensity of pixels is small because the total intensity of the least significant 4 bits is less than 12% of the maximum intensity. An exact reproduction of the image can be obtained by flashing the eight bit-plane-images in rapid succession on the screen at a rate of frame frequency x number of bits (2 ms or less for an eight bit image). The number of times each bit plane image is flashed per unit time is varied and/or the intensity of light source is varied to achieve higher reduction in power consumption.

Intensity control of the light source (backlight or front light) in a pre-determined sequence can be achieved either by modulating the voltage/current of the light source as necessary or by controlling the duration of each bit-plane-image according to its bit weight/pulse width modulation of light source (backlight source)/number of backlight (light sources) switch ON and combinations of some or all these methods to achieve optimum efficiency of backlight. Just two voltages are required to switch the pixels to the extreme states (either ON or OFF) and therefore the data drivers for the display is extremely simple as compared to the data drivers of display devices.

The number of time intervals to display gray shades is equal to the number of gray shade bits or the number of time intervals to display gray shade can be changed to accommodate the dynamic range of the backlight or front source Also the technique is used to achieve colour display with colour sub-pixels and also to achieve colour with sequential colour mode. Multiple colour sources are used to illuminate the display in sequential manner to display colour images. Flicker free images can be displayed if pixels are switched above 500 Hz to display 8-bits of gray at a frame frequency of 50 or 60 Hz. In colour sequential mode the pixels are switched at least three times faster than gray shade mode.

Blue phase liquid crystal display (BPLCD) exhibits sub-millisecond response times even with large (13 μm) cell gap, has wide viewing angle, and do not require surface alignment. However, high drive voltages (40 to 200 volts) limit adoption of BPLCD into main stream. Conventional data drivers of LCD have digital to analog converters (DACs) that are too complex for high voltage drivers. On the other hand, BPLCD can be driven like a device with instantaneous response because it has short response times. Bit slice addressing (BSA) needs just two voltages in data waveforms and therefore it eliminates DACs in data drivers. High output voltage can be achieved with simple level shifters. Colour purity of images due to a viewing angle characteristic that is independent of gray shades, low cost of data drivers and low power consumption of light source are some advantages of BSA.

The BSA technique can be used to drive fast responding LCDs, DMD and other non-emissive displays with short (sub-millisecond) response times. BSA is a sequential process wherein each bit of a gray shade is used, one at a time to drive a display. Intensity of light source for each bit-plane-frame (BPF) is determined by its bit weight. For example to display 256 shades of gray, the bit b₇ is used to drive pixels in LCD with fast response so that light is transmitted when b₇=logic-1 and light is blocked when b₇=logic-0. Intensity of light source is set to the maximum (100%) when BPF of b₇ is displayed on LCD for a duration Ta. Next, BPF of bit b₆ is displayed for an equal duration of time (Ta) by using just b₆ to drive LCD and intensity of light source is set to 50% of the maximum. BPFs of subsequent bits viz. b₅, b₄, b₃, b₂, b₁, and b₀ are displayed with light source intensities of 25%, 12.5%, 6.25%, 3.13%, 1.56%, and 0.78% respectively; i.e., intensity of light source is reduced to 50% for each successive lower bit in descending order. Light intensities of light source (backlight or front light) to display 256 gray shades in 8-time intervals are shown in FIG. 4(a). If F is the frame frequency of conventional LCD to avoid flicker, then frame frequency of BPFs has to be at least g·F for monochrome images and 3·g·F for colour images.

Cost of data drivers is reduced drastically by adapting the BSA because the digital to analog converters (6 to 10 bits) for displaying gray shades are eliminated in the column drivers of the LCD and are replaced with simple 2:1 multiplexer to switch pixels to either ON or OFF states or a level shifter as shown in the FIG. 11. The hardware required to drive the pixels in the present disclosure is just 1-bit DAC or a digital level shifter for each column of the display.

The inherent intensity modulation of light source (backlight or front light) in this disclosure has the same effect as backlight blinking (because of the large dynamic range of backlight intensities for the bit-plane-images) and is very useful to reduce the motion blur on the display devices. This disclosure is useful for reducing the hardware complexity and cost of drivers and can be used in non-emissive displays including AM-LCD, fast responding LCDs, DMD, MEMS displays and bi-stable devices like ferroelectric display. The idea of sequential display of bit-plane-images with appropriate intensity control can be used for emissive display as well. The bit-plane addressing is employed in emissive type of displays to reduce driver circuit and the cost either by controlling the current or the voltage to display each bit plane image. The sequence of bit-plane addressing is changed to reduce motion related artefacts on the display.

Intensity modulation is for the entire light source unit that illuminates the display. Light emitting diodes (LED) are replacing florescent tubes as light source. Pulse width modulation can be used for intensity modulation LED or the number of LEDs that illuminate the display also can be varied or a combination of both these methods can also be used to achieve the intensity control of light source that illuminates the non-emissive display. Dynamic range of light source (backlight) intensity is (2^{(g-1)}−1) when all BPFs of g-bits are displayed for equal durations of time (Ta) as shown in FIG. 4(a). Dynamic range can be reduced by about 44% when BPF of b₇ is displayed for a period Ta′=1.78Ta and rest of the seven BPFs are displayed for a period 0.89Ta as shown in FIG. 4(b). Total period to display 8-BPFs is conserved (8Ta); so that, the image refresh rate is same for both the cases shown in FIGS. 4(a) and 4(b) respectively. Intensity of LEDs is usually controlled by pulse width modulation. Hundreds of LEDs are used in light source i.e. backlight of a large LCD and number of LEDs that are switched ON and OFF may also be varied to achieve the intensity modulation of light source. A combination of intensity control of each and every LED along with a control of number of LEDs that are used to illuminate the display for each bit plane frame.

The light source (backlight or front light) is controlled to save power in LCD and other non-emissive displays. The average picture level (APL) of movies is about 25% [1] and therefore a good percentage of frames (Images shot in moonlight, darkroom, night-scenes etc.) will have not have pixels with the maximum intensity. MSB and to a lesser extent other MSBs of gray shade in such frames will be logic-0 and the light source can be switched OFF when the corresponding bit-plane-image(s) is displayed. About 50% reduction in power consumption in a frame can be achieved if MSB of all the pixels is logic-0 (assuming linear relation of intensity and power consumption of backlight). Similarly the reduction will be 75% if light source is switched OFF during the time intervals when the 2-MSBs with logic-0 are displayed. The reduction is 87.5% if 3-MSBs are logic-0 in a frame. It is important to note that power saving is possible each and every frame that meets this condition because the light source switching can be accomplished on the fly because the algorithm to switch off the light source depends just on the gray shade data of pixels. It is not necessary to analyse the image or obtain the histogram of the image.

Similarly, when pixel data has logic-0 for a sizeable portion of the frame but not the whole frame then 1-D backlight switching can be implemented to reduce power consumption. This approach is compatible with displays that backlit with cold cathode fluorescent lamp (CCFL) or hot cathode fluorescent lamp (HCFL) that are linear in structure.

Further reduction in power dissipation is achieved even when images with good brightness and high contrast are displayed with this disclosure. Neighbouring pixels in most images are highly correlated and therefore the variation of intensity among neighbouring pixels is small. Hence most of the pixels in bit-plane images; especially, the most significant bit planes form clusters of pixels that are driven to same state. About 50% of pixels in most of the bit-pane images are OFF and therefore good number of black clusters as in FIGS. 2(b), 2(c) and 2(d) can be seen in bit-planes-images of MSBs and the backlight power is wasted illuminating such clusters. Such large clusters are common even in images with high contrast and good brightness. A coarse two dimensional array of backlight that illuminates the display can be used to reduce power consumption by switching OFF power to backlights that are behind the black clusters in a bit-plane image. Optimum size for the area covered by each backlight will depend on the image and Table 1 and the reduction in power consumption will depend on the image as well as the number of bit-planes with backlight control. Table 1 gives the reduction in power dissipation for the test image shown in FIG. 8 and its dependence on the size of the cluster that is illuminated by a backlight and the number of bit-planes used for backlight control.

TABLE 1
Percentage reduction power for the test image and its dependence on
block size of light source in 2-D switching of light source (backlight):

| | Backlight | Backlight | Backlight |
|---|---|---|---|
| | switching of | switching | switching of |
| | MSB (1-bit | of bit 8 & | bits 8, 7 and |
| Block size | only) | 7 (2-bits) | 6 (3-bits) |
| 16 × 16 pixels | 12.33% | 24.32% | 30.31% |
| 32 × 32 pixels | 10.64% | 20.73% | 25.83% |
| 64 × 64 pixels | 6.25% | 13.39% | 16.15% |

About 16 to 30% reduction can be achieved by controlling the light source (backlight or front light) in three most significant bit-plane-images and such a reduction is possible in many images with high contrast and good brightness as shown in Table 2 when each backlight illuminates a cluster of 16×16 pixels and the test image of size 1024×1024 has a good reduction (about 30%) of power consumption. Images digitized to 512×512 pixels have about 25% reduction in power consumption if backlights illuminate clusters of 8×8 pixels as shown in Table 3.

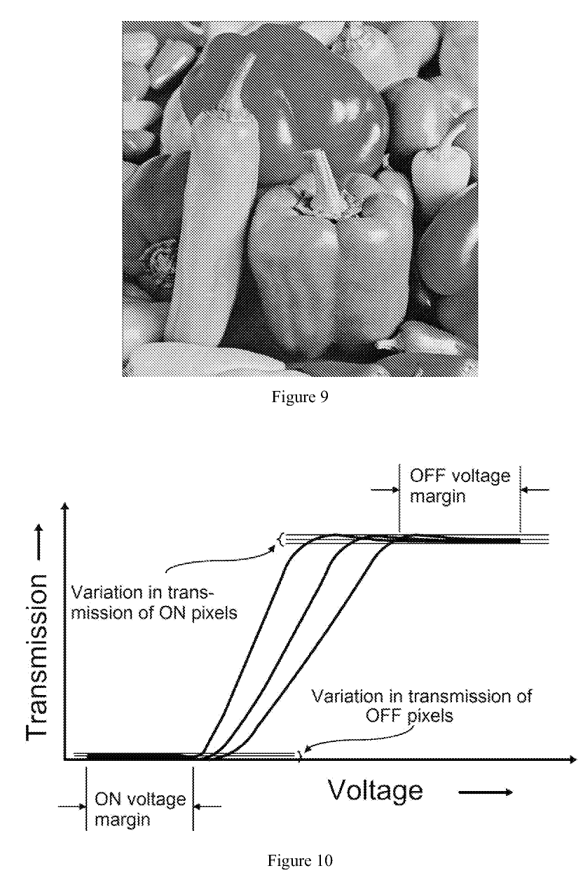

TABLE 2
Percentage reduction power for images when 256 (16 × 16) pixels
form a block and are illuminated these blocks are switched

| | Backlight | Backlight | Backlight |
|---|---|---|---|
| | switching of | switching | switching of |
| | MSB (1-bit | of bit 8 & | bits 8, 7 and |
| Image | only) | 7 (2-bits) | 6 (3-bits) |
| Lena (512 × 512) | 9.38% | 13.53% | 14.34% |
| FIG. 2(a) | | | |
| Barbara (512 × 512) | 12.69% | 15.36% | 15.89% |
| FIG. 7(d) | | | |
| Test image | 12.33% | 24.32% | 30.31% |
| (1024 × 1024) FIG. 8 | | | |
| Pepper(512 × 512) | 12.69% | 16.19% | 16.44% |
| FIG. 9 | | | |

TABLE 3
Percentage reduction power for images when 64
(8 × 8) pixels form a block for backlight switching

| | Backlight | Backlight | Backlight |
|---|---|---|---|
| | switching of | switching | switching of |
| | MSB (1-bit | of bit 8 & | bits 8, 7 and |
| Image | only) | 7 (2-bits) | 6 (3-bits) |
| Lena (512 × 512) | 14.94% | 21.62% | 23.34% |
| FIG. 2(a) | | | |
| Barbara (512 × 512) | 17.90% | 22.87% | 23.96% |
| FIG. 7(d) | | | |
| Pepper(512 × 512) | 18.56% | 25.07% | 26.27% |
| FIG. 9 | | | |

Power consumption of displays in computer monitors, notebook PCs, digital camera etc., wherein the images are displayed with high contrast and good brightness can also be reduced with the 2-D switching of backlight as evident from Table 2 and Table 3.

Backlight or front light switching scheme is based on a simple feed-forward algorithm is obtained directly from the gray shade data and it can be implemented on the fly in each and every frame for both static and dynamic images with high contrast. The algorithm does not depend on histogram or analysis of images. About 25% reduction in power consumption can be achieved for images with high contrast and good brightness with appropriate size of the cluster for backlight. The theoretical limit of 75% can easily achieved in movies with average picture level of 25% because the technique can achieve reduction in power consumption all the frames irrespective of the brightness of the images in frames.

By using the technique mentioned in the present disclosure a drastic reduction in complexity, cost and power consumption of data drivers in the display devices is achieved. Elimination of motion blur due to inherent modulation intensity depending on the bit-plane of the image. Bit slice approach is not only applicable to AM-LCD but also other emissive, fast responding LCD's, non-emissive displays including bi-stable displays, DMDs and MEMS displays. A simple feed-forward algorithm that is easy to implement on the fly because it just depends on pixel data and does not need any analysis or histogram enabling power reduction in each and every frame.

Low Power with Light Source Switching

BPF or binary image of higher (more significant) bits of all images have some clusters of ‘OFF’ pixels that are black as can be seen in FIGS. 3(b) and 3(c). Light source i.e. backlight or front light can be switched ‘OFF.’ selectively if all pixels are OFF in a predefined mosaic of cluster (for example: 16×16 pixels 24×24 pixels or 32×32 pixels etc.) or multiple number of clusters in BPIs. It is similar to 2-D dimming techniques of light source except that the light source is switched OFF rather than reducing the intensity. Major saving in power can be achieved by switching OFF light source for BPFs of most significant bits. For example, in the binary image of most significant bit (b₇) of green colour image of “Lena” there are 56 clusters of pixels out of 256 clusters shown in the FIG. 14 wherein all pixels are black and therefore about 20% saving in backlight power can be achieved by switching OFF backlight to the 56 clusters of pixels.

A maximum of 41.85% and an average of 26.9% reduction in power consumption of light source were achieved in an analysis of 27 standard static images with good contrast. Bit-slice addressing saves backlight or front light power of the display device not just for dim images but also for images with high contrast.

The following are the advantages of BSA used in the display devices:

The cost and complexity of data drivers is reduced by using BSA to drive the fast responding displays. Reduction in hardware complexity depends on the number of grayscale bits. About 80% reduction in hardware complexity is achieved by eliminating DACs and the associated multi-bit shift registers and the multi-bit latches when BSA is used to drive fast LCD's or other display devices. Simple drivers with voltage level shifters that increase the output voltage for logic-1 to high voltage (100-200 volts) are adequate to drive each column of BPLCD and other type of LCD need much lower voltages (5 to 10 volts).

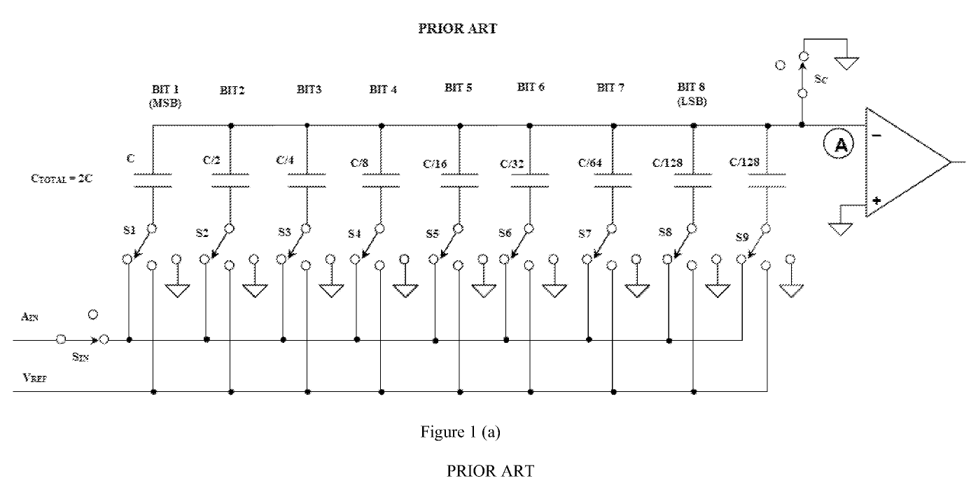

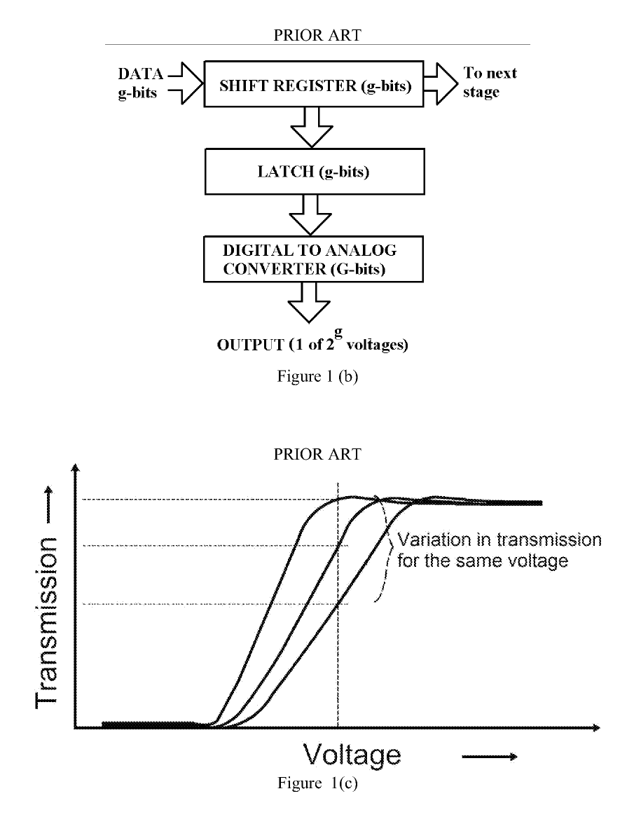

Viewing angle characteristics of LCD driven with the BSA is independent of gray shades because pixels are driven either to ‘ON’ state or ‘OFF’ state even when gray shades are displayed. Hence whenever light is allowed it has the same viewing angle because pixels in the display have the same viewing angle characteristics when they are ON'. It is helpful to maintain the colour purity over the entire viewing angle of LCD because viewing angle of the primary colours will not depend on its gray value when BSA is used and therefore colour mixing will be uniform in all angles as compared to AMLCD driven with conventional method wherein the viewing angle depends on grayscale value because the slope of the electro-optic characteristics is used to display for grayscales and the slope depends on viewing angle as illustrated in FIG. 1(c).

Voltage margins to drive pixels is large because pixels are driven to either ON or OFF state in BSA and the electro-optic response curve is almost flat above the saturation voltage and also below the threshold voltage as shown in FIG. 6.

Bi-stable displays can also be driven with BSA because the bi-stable displays has the sample and hold characteristics of AM-LCD and the short or long term memory in the display is also useful for BSA and can eliminate the active matrix backplane of AM-LCD.

The BSA eliminates motion blur in the videos because intensity of light source is less than 1% of the maximum for b₀; intensity profile of light source decays exponentially and it is similar to that of light decay in CRT and it has better effect than interleaving blank frames to suppress motion blur in LCD. The intensity profile has an exponential decay which is similar to that of CRT (cathode ray tube) displays. Therefore, the BSA eliminates motion blur due to fast moving images.

Critical flicker frequency can also be reduced by reordering bit sequences for displaying BPFs using the BSA. For example, the following sequences will reduce flicker and also eliminate motion blur: b7, b0, b6, b1, b5, b2, b4, b3 OR b7, b3, b6, b2, b5, b1, b4, b0 by increasing the flicker frequency of light source.

Lower power consumption of light source illuminating the display can be achieved by selectively switching OFF light source to small clusters of pixels in BPFs. For example, 26.2% reduction in light source power is achieved even for a static image with full contrast for the image shown in 3(a).

The applications of BSA includes DMD which uses pulse width modulation (PWM) to achieve grayscales, BSA can be used with LED light source to achieve gray shades so that the micro minors in DMD can be operated at slower clock i.e. frame refresh rate of DMD is reduced by a factor (255/8) when 256 grayscales are displayed.

### REFERENCES

1) Kikuchi H et al. “Polymer stabilized liquid crystal blue phases.”, Nature Mat., Vol. 1, pp 64-68, (2002).
2) Kuan-Ming Chen et al. “Sub-millisecond gray level response time of a polymer stabilized blue-phase liquid crystal.”, IEEE/OSA JDT, Vol. 6, No. 2, pp 49-51, (2010).
3) N A Clark and S T Lagerwall, “Sub-microsecond bistable electro optic switching in liquid crystals.” Appl. Phys. letters 36, 899, (1980).
4) T. Shiga and S. Mikoshiba, SID. '03 Technical Digest, p. 1364 (2003).
5) Pierre de Greef, JSID 14/12, p. 1103 (2006)
6) T. Yamamoto, LCD Backlights, John Wiley, (2009).
7) T. N. Ruckmongathan, An addressing technique to drive blue phase LCDs, proceedings of IDW '10, Fukuoka, December 2010, p. 607-608.

Finally, while the present disclosure has been described with reference to a few specific embodiments, the description is illustrative of the disclosure and is not to be construed as limiting the disclosure. Various modifications may occur to the disclosure by those skilled in the art without departing from the true spirit and scope of the disclosure as defined by the appended claims.

We claim:

1. A bit slice addressing method to display an image on a display device by combining electrical and optical means, said method comprising acts of:
a. displaying binary images of a predetermined number of grayscale bits in succession;
b. modulating simultaneously the intensity of light source for each binary image of grayscale bits; and
c. displaying the intensity modulated binary images at a predetermined rate to view the complete image.

2. The method as claimed in claim 1, wherein the display device is a non-emissive display device selected from a group comprising of transmissive type of display, reflective type of display and trans-reflective type of display.

3. The method as claimed in claim 1, wherein the display device is an emissive display with pixels are driven in binary mode and the intensity of all ON pixels in the binary image is controlled depending on the grayscale bit of the binary image.

4. The method as claimed in claim 1, wherein the display device is a fast responding liquid crystal displays (LCD) such as blue phase LCD (BPLCD) and ferroelectric LCD (FLCD).

5. The method as claimed in claim 1, wherein the display device is a digital Micro-minor device (DMD).

6. The method as claimed in claim 1, wherein the display device is a micro-electro mechanical system (MEMS) based display.

7. The method as claimed in claim 1, wherein the display device is an electro-wetting display.

8. The method as claimed in claim 1, wherein the binary images of the bit-planes are displayed with drivers that can apply any one of two predetermined voltages to the display.

9. The method as claimed in claim 1, wherein the integral of intensity of light during the period of each binary image is proportional to its binary weight.

10. The method as claimed in claim 1, wherein the product of light intensity and duration of light is proportional to binary weight if the light intensity is constant during a period.

11. The method as claimed in claim 1, wherein the light intensity is proportional to binary weight of the binary image if durations of display of binary images are equal.

12. The method as claimed in claim 1, wherein the number of occurrences of binary image and the intensity of ON pixels in the binary images are controlled depending on bit weight of binary image.

13. The method as claimed in claim 1, wherein the intensity of ON pixels in binary images increased and the number of occurrences of binary images is reduced for least significant bits of grayscale to reduce the dynamic range of the intensity of light source.

14. The method as claimed in claim 1, wherein the intensity of ON pixels in binary images increased and the number of occurrences of binary images is reduced for some least significant bits of grayscale to reduce the number of binary images displayed per unit time.

15. The method as claimed in claim 1, wherein the light source is switched OFF for a predetermined time to allow pixels to switch from one state to another state during transition from one binary image to another binary image.

16. The method as claimed in claim 1, wherein the duration of the binary image and the duration of light intensity are changed in a predetermined manner.

17. The method as claimed in claim 1, wherein the number of light sources that are switched ON or OFF is controlled in a predefined manner to achieve intensity modulation of light.

18. The method as claimed in claim 1, wherein the number of light sources that are switch ON as well as the ON period of each light source are controlled to achieve intensity modulation of light.

19. The method as claimed in claim 1, wherein intensity modulation of light source is achieved by varying the power applied to the light source.

20. The method as claimed in claim 1, wherein the light source is switch OFF for a binary image when a grayscale is logic 0 for all the pixels in the binary image to reduce power consumption of the displays.

21. The method as claimed in claim 1, wherein the light source is switch OFF for clusters of pixels in binary image with grayscale bit as logic 0 to reduce power consumption.

22. The method as claimed in claim 1, wherein light source is switched OFF for clusters of pixels in binary images of a few most significant bits of grayscale to reduce power consumption of the light source in images with full contrast.

23. The method as claimed in claim 1, wherein a predetermined sequence is employed to display binary images of grayscale bits to eliminate motion blurs.

24. A system to display an image on a display device with bit slice addressing technique comprising:
a. a display screen to display an image, wherein the display is selected from a group comprising fast responding liquid crystal displays (LCD) such as blue phase LCD (BPLCD) and ferroelectric LCD (FLCD), digital micro-mirror device (DMD), micro-electro mechanical system (MEMS) displays and electro-wetting display;
b. data drivers to drive the display consisting of a 1-bit shift register, a latch and 2:1 analog multiplexer to drive the display;
c. light source to vary intensity of ON pixels in binary images; and
d. a controller to control the light source by varying the number of light sources that are ON and the duration for which the light sources are ON.

25. The system as claimed in claim 14, wherein the 2:1 analog multiplexers are replaced with level shifters.
